(19) United States
(12) Patent Application Publication
(10) Pub. No.: US 2003/0154180 A1
(43) Pub. Date: Aug. 14, 2003

(54) Profile management system

(76) Inventors: Simon J. Case, Saxmundham (GB); Nader Azarmi, Colchester (GB); Marcus Thint, Boca Raton, FL (US)

Correspondence Address: NIXON & VANDERHYE P.C., 8th Floor, 1100 North Glebe Road, Arlington, VA, 22201, US

(21) Appl. No.: 10/073,267

(22) Filed: Feb. 13, 2002

(51) Int. Cl. G06F 7/00

(52) U.S. Cl. 707/1

(57) ABSTRACT

A profile management system, for use with information processing applications which retrieve information on behalf of a user. The system comprises a profile generator which generates default user profiles. The profile generator can identify user-specific information from, for instance, an organisation chart such that new members of an organisation are automatically assigned a profile. This enables information processing applications to provide new members with information that is relevant to their role within an organisation.

The present invention relates to profile management systems, particularly where users are provided with profiles and information is retrieved with reference to the profiles.

Profile-based information retrieval systems are known in which a user is provided with a profile, including for instance a set of keywords representing an interest, and the profile is available for use by one or more applications. These applications typically use the information in the profile to retrieve information for that user.

Considerable work has been done on developing user profiles. For instance it is known (i) to monitor computer environment “desktop” settings, (ii) to monitor activity based on click-streams through a sequence of web pages, (iii) to monitor documents accessed by a user and to modify the profile in accordance with documents selected by a user, and (iv) to monitor e-mails to or from the user and to modify the profile based on information extracted from the emails. With these known systems the profile store is either integral with the information retrieval system, or the information retrieval system has write access to a profile store. In either case, the information retrieval system can directly update the user profile based on user behaviour.

It is also known to exchange profile information between individuals and service-providing parties, with built-in safeguards for individual privacy. In particular, the Open Profiling Standards, available from ttp://developer.netscape.com/ops/ops.html, have developed a standard for client-based profiles (i.e. the profile is stored on the client), where Web site providers collect information about users' names, addresses, age, gender, zip code, country, income range (if provided) etc., and, having collected this info for a large number of users, compile statistics about their clients (market). Web site providers use these statistics, which are generally referred to as demographic information, in a simple matching exercise to target aspects of a Web site such as banner advertisements.

A problem with existing profile generator systems is that they build a profile on the basis of either computing environment settings, user activity based on click-streams through a series of web pages, or shallow topics of interests such as “sports”, “entertainment”, “history”, etc. Profiles thus built do not accurately reflect the user's interest, and information identified on the basis there of is often inaccurate and irrelevant.

Furthermore these known systems develop bespoke profiles on a per user basis, which is time consuming and means that the profiles so-developed are a considerable administration overhead.

According to embodiments of the present invention, there is provided apparatus for generating a user profile for use in an information management system, where the user profile comprises interests deemed to be relevant to a user. The apparatus comprises: classification means for classifying a user as a type of entity; a mapping store comprising data indicative of mappings between entity type and interests; a template store comprising one or more templates each comprising a plurality of interests; identifying means in operative association with the mapping store and the classification means and arranged, in use, to identify data indicative of interests relevant to a user in accordance with classification of the user; to retrieve a template from the template store; and to generate a user profile from the retrieved template in accordance with the identified interests.

The apparatus might for instance output the generated user profile to a user profile store, and/or to a terminal for display.

Conveniently the classification means is in operative association with a data structure, elements of which are representative of entity type.

A profile management system incorporating embodiments of the invention provides semi-automated updating of user profiles and a default profile generator that creates initial profiles for new users. Conveniently, in an organisational context, the data structure might include one or more organisational charts, so that an entity type represents a role within the organisation. Alternatively the data structure might include a set of “personalities” (e.g. “sportsman”, “techie”), or possibly a hierarchy comprising a random assignment of interests. An administrative user interface is also provided to create and edit the data structure (e.g. default personalities and organization-specific interest hierarchies). Additionally, a data structure (personalities and organizational hierarchies) can be loaded from text files.

This means that embodiments of the present invention can be used to generate default user profiles for new joiners to an organisation, in dependence on their role within the organisation. In an organisation subject to change, embodiments of the present invention also offer a means for adapting user profiles so far as necessary throughout the organisation by modifying the organisational chart and mappings.

Embodiments of the present invention are particularly useful in information management, for example in a corporate environment or e-community of leisure users associated by a common link (location-based or interest-based). It can be important in the corporate environment that users are supplied with, or indeed barred from, information of particular types. For instance, information on company cars from a human resources department may only be of interest to users who are entitled to company cars. In the management domain, it may be important that documents of a particular confidentiality status are only made available to users at a certain level in the organisation, or in a particular department. Access to such information and documents can be controlled through user profiles and it can thus be important to constrain changes that can be made to user profile templates rather than allowing individual users to make changes thereto.

Profiles generated in accordance with embodiments of the invention allow for a rich, extended description of a topic with unlimited keywords and phrases, include both “positive” and “negative” keywords, support hierarchical relationships between interests such that interests in the hierarchy inherit their parent's characteristics, have associated “importance” level attributes, have associated “privacy” level attributes, have associated “expertise” level attributes, have associated “duration” factor attribute, have associated “preferences” attribute in which who/what/when/where aspects of the interest are stored, and provide full access and control by the profile owners (users). In addition, the keywords can be weighted to indicate a level of relevance (positive keywords) and irrelevance (negative keywords) to an interest.

Preferably, the individual user has write access to the user profile generated by the identifying means so that they can modify the user profile to suit their individual requirements—for instance by adding interests or contexts. Similarly, write access might be provided for a system manager. It may be appropriate to allocate different access rights to these roles.

Thus the advantages of embodiments of the invention include (i) more accurate filtering and delivery of information for the users, (ii) profile maintenance by users and administrators, (iii) provision of privacy control, and (iv) user profiles are dynamic and kept up-to-date via manual or semi-automatic updating.

A profile management system will now be described, by way of example only, as an embodiment of the present invention, with reference to the accompanying drawings in which:

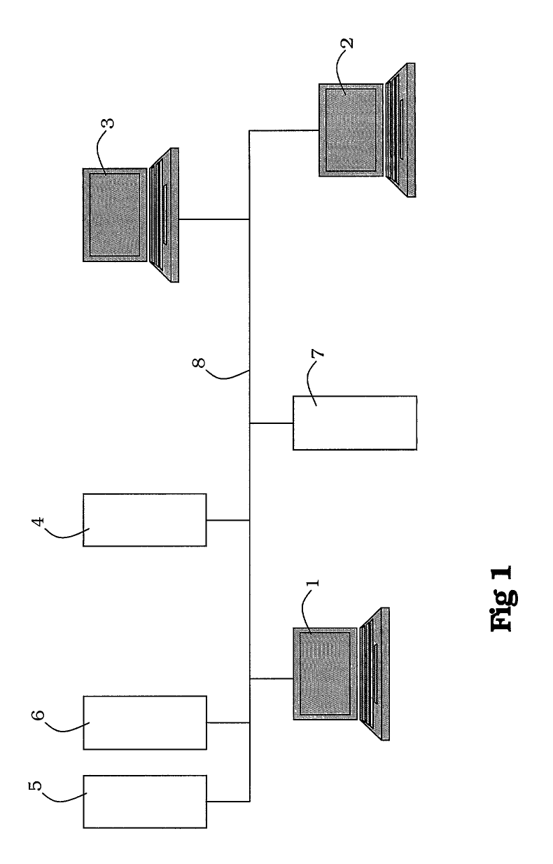

FIG. 1 illustrates an overview of an environment within which embodiments of the invention operate;

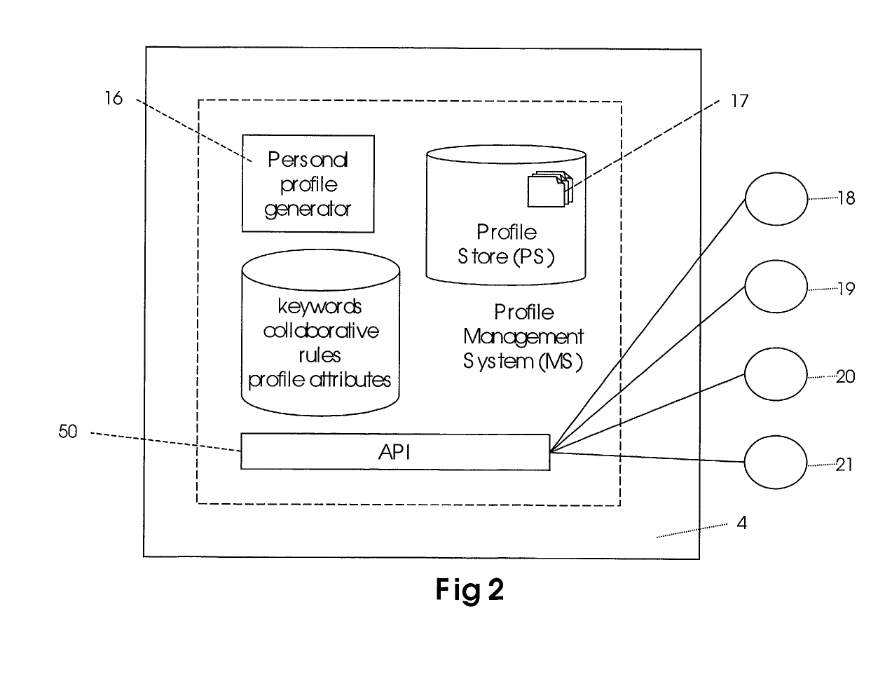

FIG. 2 illustrates an embodiment of a profile generator according to the invention in the context of a profile management system;

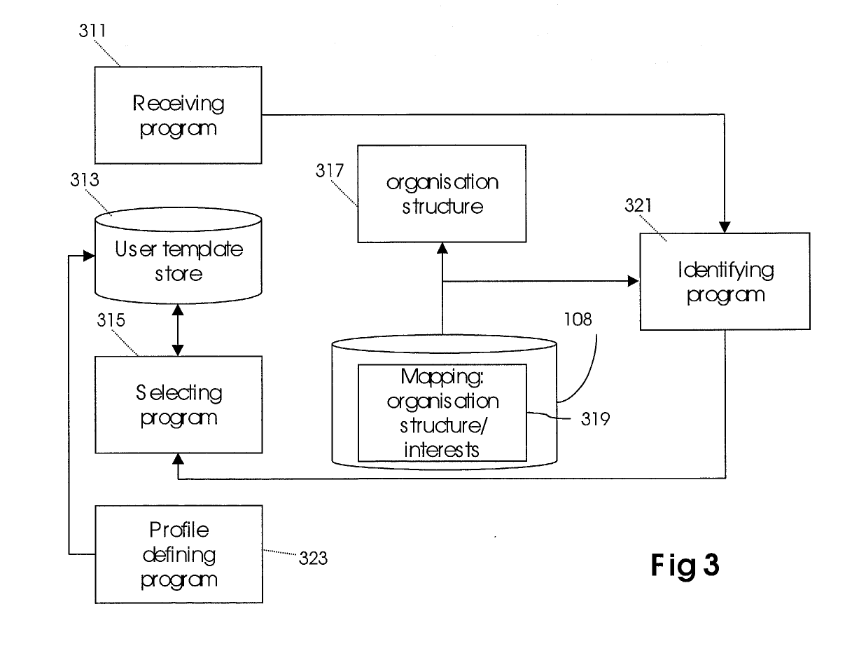

FIG. 3 shows components of the profile generator of FIG. 2;

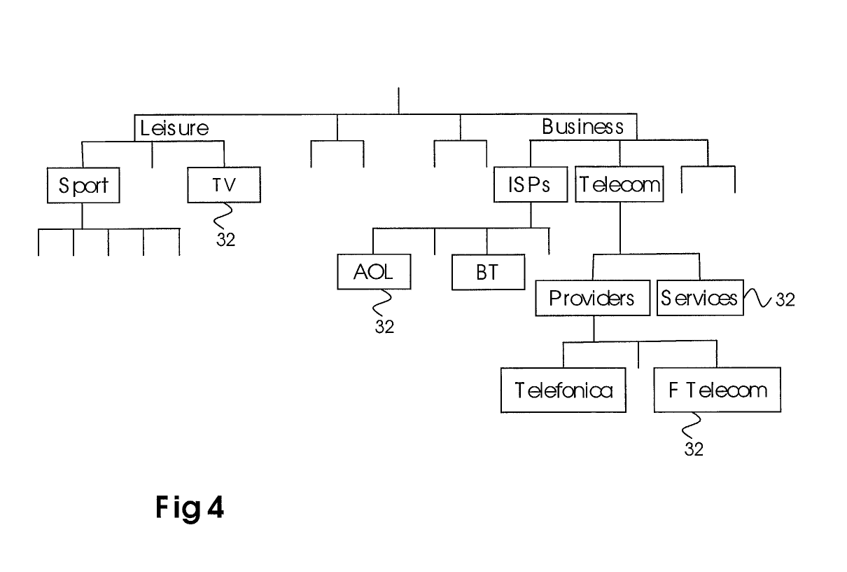

FIG. 4 shows a prebuilt interest hierarchy for use in building a template user profile;

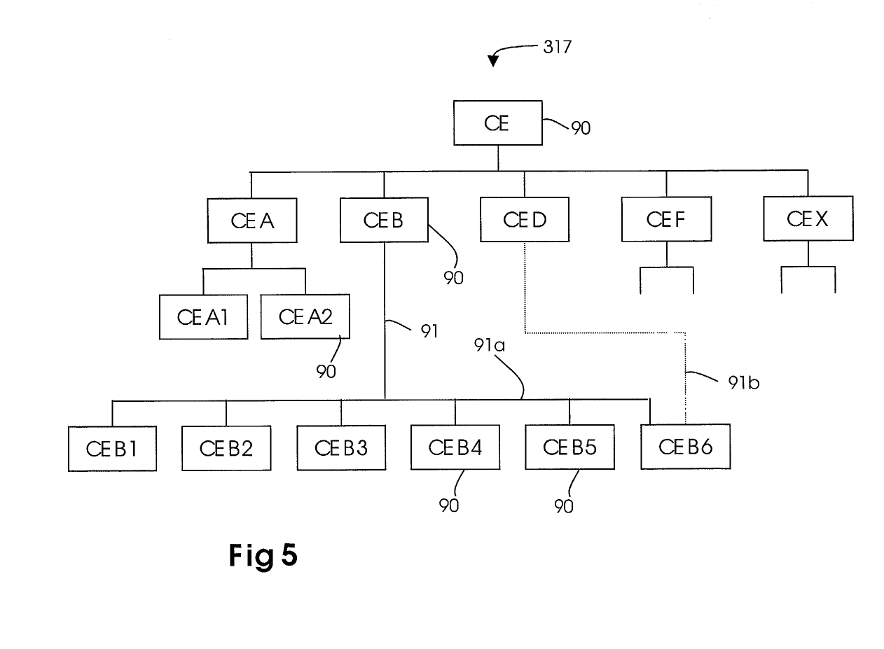

FIG. 5 shows an organisational hierarchy for use with the prebuilt interest hierarchy of FIG. 4 in building a template user profile, and

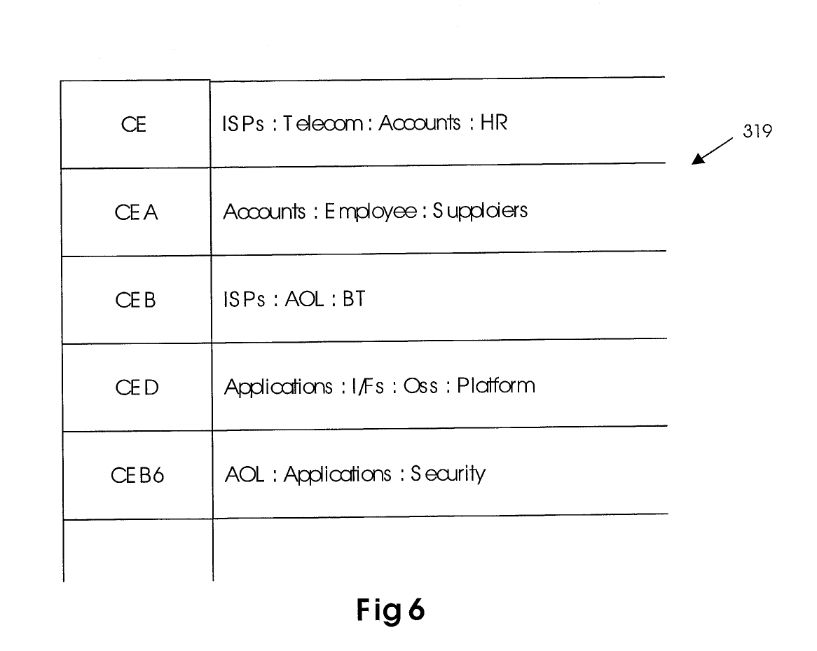

FIG. 6 shows a mapping between roles in the organisational hierarchy of FIG. and interests.

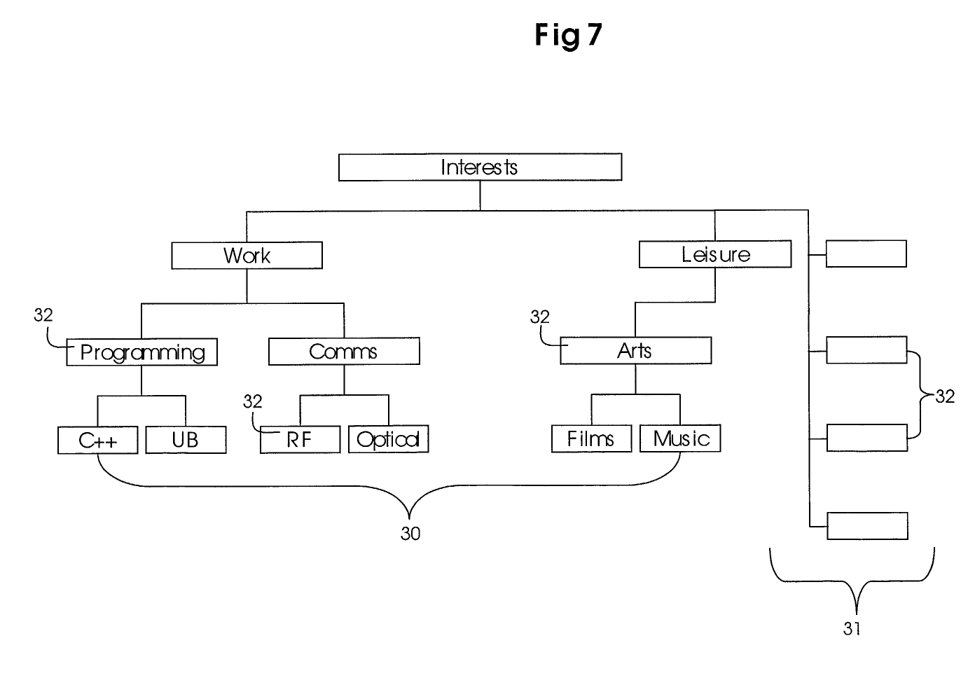

FIG. 7 illustrates a personal profile;

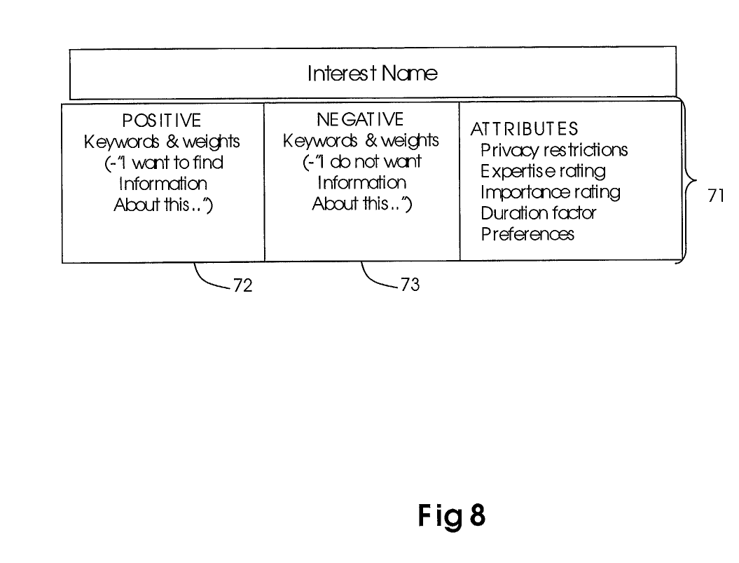

FIG. 8 shows the contents of an Interest Category in a User profile;

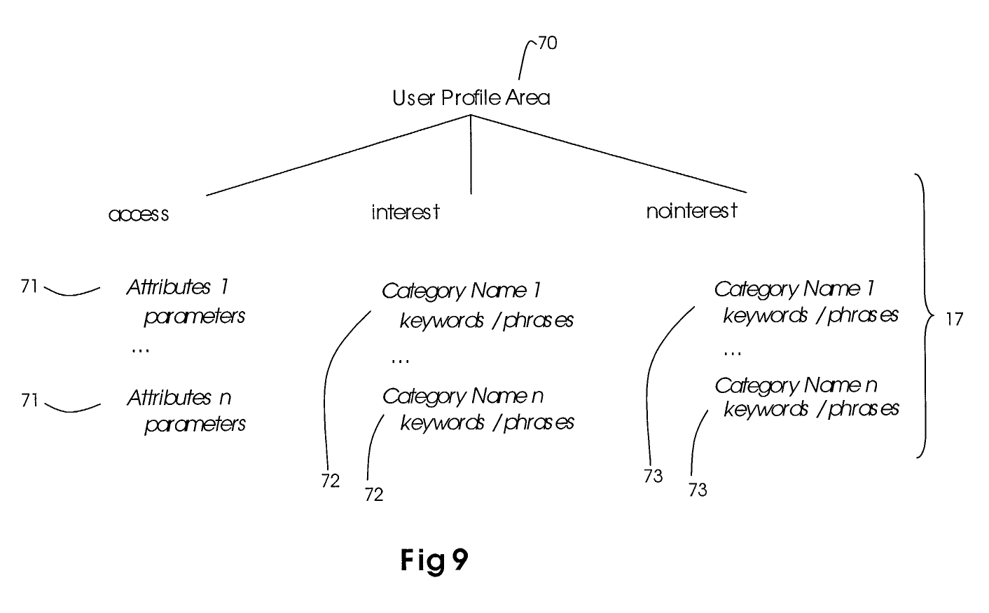

FIG. 9 shows a file structure for storing the contents of the personal profile of FIG. 7;

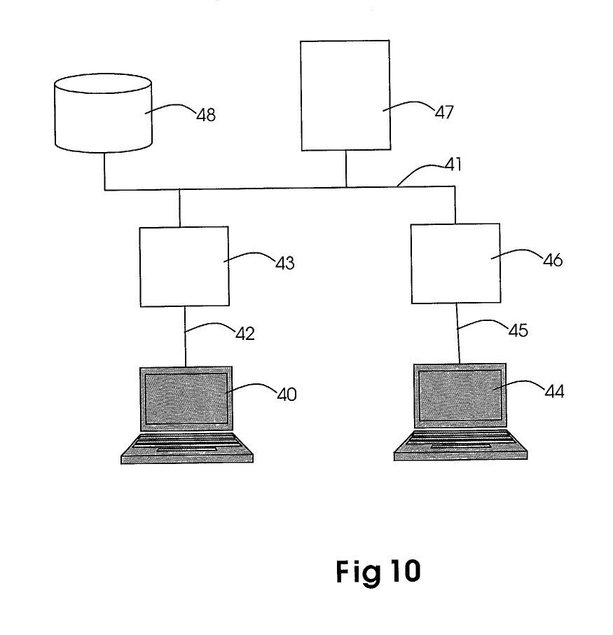

FIG. 10 illustrates alternative operating environments for embodiments of the present invention.

### OVERVIEW OF AN EMBODIMENT OF THE INVENTION

FIG. 1 shows an environment in which a first embodiment of the present invention can operate. First, second and third client terminals 1, 2, 3, a personal profile server 4, and first and second application servers 5, 6 are interconnected by a network 8. The network 8 may comprise a local area network, the Internet or a combination of local area networks and the Internet.

Referring to FIG. 2, embodiments of the invention are generally referred to as a personal profile generator 16. The personal profile generator 16 is stored and run on the personal profile server 4. The personal profile generator 16 is part of a profile management system MS, and has access to a user profile store PS, which is either located on, or remote from, the profile server 4, and stores personal user profiles 17 (in FIG. 2 the profile store PS is shown on the profile server 4). The profile management system MS includes an Application Programming Interface (API), which allows external applications to communicate with the profile generator 16. In addition, the profile management system MS provides storage for user-specific search criteria such as keywords, collaborative rules, and all profile attributes.

The profile generator 16 described in detail below is suitable for use in an environment in which multiple software applications, as well as users, have access to the user profile store PS. The content of a user profile is used by an application to search multiple information sources, such as Web sites, and deliver search results to the user.

FIG. 2 shows applications 18, 19, 20, 21 communicating with the profile management system MS via the API, for example using remote procedure calls compatible with the API. The remote procedure calls are either compliant with agent communication language protocols established by the Foundation for Intelligent Physical Agents (FIPA), or employ method calls which are accessible to any application that wants to communicate with the profile generator 16. For further information on FIPA Standards, the reader is directed to FIPA specification, Part II: Agent Communication Language, Foundation for Intelligent Physical Agents, 28^{th} November 1997.

The applications 18, 19, 20, 21 perform various tasks for a user, such as ad hoc information retrieval and identification of people with interests in common with the user. The common feature of these application agents is that they can request, from the profile management system MS, details from a user's profile 17 and provide feedback, which can be used by the personal profile generator 16 to modify a profile.

In the present example, the applications 18, 19, 20, 21 act as Web server applications so that a user can interact with them via a Web browser located on one of the client terminals 1, 2, 3. The exemplary applications 18, 19, 20, 21 are respectively a Web search engine 18, which searches for information that may be relevant to a user; a new interest suggesting agent 21, which proactively identifies interests of relevance to a user; an “over-the-shoulder” information retrieval agent 20, which monitors the behaviour patterns of users; and a “matchmaking” agent 19, which identifies groups of users having similar interests to the user. As the profile management system MS interacts with applications that provide collaborative working functions across a user group, the profile management system MS authenticates incoming requests for information from the profile management system MS.

The embodiment can be used to automatically generate a user profile. This is particularly useful in corporate environments, where it can be convenient to assign certain interests and memberships of user groups to employees as a function of their job description. In addition user profiles can be used to specify, for example, subject matter to which users are denied access. The profile generator 16 could be used in a company restructuring exercise, where new roles are created; in this instance the profile generator 16 could be used to define default profiles relevant to new activities or access rights.

Referring to FIG. 3, an embodiment of the invention will now be described in more detail. The profile generator 16 comprises a receiving program 311 for receiving a request for creation of a user profile in respect of a user, a store 313 comprising user profile templates, a program 315 for selecting a user template from the store 313, an organisational structure 317, a mapping 319 between interests (or user profile templates) and location in the organisational structure 317. The profile generator 16 additionally comprises a program 321 arranged both to identify the user in the organisational structure 317, and to access the mapping 319 in order to identify interests (or user profile templates) corresponding to the identified location in the organisational structure 317.

If the identifying program 321 identifies interests from the mapping 319, it passes the identified interests to the selecting program 315, which selects a template from the profile template store 313 and filters the selected template in accordance with the identified interests, thereby generating a bespoke user profile for the user.

If the identifying program 321 identifies a user profile template, an identifier representative of the identified template is passed to the selecting program 315, which selects an appropriate user profile template from the store 313. In this case, selection of a user profile template automatically involves selection of interests for that user, as each template has default interests associated therewith.

The organisational structure 317, mapping 319 and identifying program 321 components of the profile generator 16 are now described in more detail, with reference to FIGS. 4, 5 and 6. In this embodiment the identifying program 321 identifies interests from the mapping store 108 and passes these to the selecting program 315.

FIG. 4 shows a user profile template which includes all interests 32 that could be expected to be relevant to a user for any of a particular community of users (not all the interests are shown in the Figure) in an organisation and FIG. 5 shows an organised data structure in the form of an organisation chart 317 for all the users in the community. Each element 90 of the organisation chart (again, not all elements are shown) has an identifier indicative of the element's role in the organisation and links 91 to associated elements 90. Typically, these links 91 are indicative of organisational reporting lines. The community of users might represent only part of the organisation or all of it.

A user in the community will usually have an assigned role in the organisation and this is indicated in the organisation chart 317 by a code: CE, CEA and so on, as shown in FIG. 5. Clearly each code can be applicable to more than one user. For the profile generator 16 to generate a user profile 17 for a new user, the identifying program 321 requires access to both the organisational chart 317 and a mapping 319 for translating the user's role into a set of interests. Mappings 319 may be stored in a mapping store 108 accessible by the identifying program 321.

Referring to FIG. 6, a mapping 319 for an organisation chart 317 may comprise a table listing the user roles CE, CEA and so on against sets of interest names. The Chief Executive, assigned role CE, is likely to have interests from several aspects of the business. In FIG. 6, these are shown as ISPs, Telecom, Accounts and HR (human resources). At a level lower in the hierarchy, a role may cover only one of these interests, such as the Chief Accountant (CEA). The interests mapped to CEA might therefore be Accounts, Employee and Supplier. At the same level there might be a business manager (CEB) whose default profile is ISPs, AOL and BT. Still at the same level there may be a technology manager (CED) responsible for providing the organisation with communications platform. The default profile for CED may thus be Applications, Interfaces, Operating Systems and Platform.

As shown in FIG. 5, a role CEB6 may officially report to the business manager CEB but may additionally have a matrix line management responsibility to the technology manager CED. The default profile for this role thus may include interests from the default profiles for both CEB and CED, such as AOL, Applications and Security.

Once the identifying program 321 has identified interests corresponding to the role of the user (e.g. CED), it passes these identified interests (here Applications: I/Fs Oss: Plafform) to the selecting program 315, which filters out all other interests from the template shown in FIG. 4. In this way only those interests identified as being relevant to role CED are included in this user's profile.

The profile generator 16 can also include a program 323 for defining interests associated with a user profile 17 and a user profile template. The following passages describe firstly, features of a user profile 17, and secondly, how interests, and attributes relating thereto, can be modified by the defining program 323.

An example of a personal user profile 17, which is derived directly from a user profile template (such as that shown in FIG. 4), or independently created by the user, is shown in FIG. 7. A personal user profile 17 comprises a collection of user interests with sets of keywords or phrases associated with each interest, together with attributes associated with each interest (shown in FIG. 8 but omitted in FIG. 7 for clarity, and described in the paragraph below). In the present embodiment, the collection of interests comprises, at any given time, a hierarchy 30 of interest names 32, and a list 31 of automatically generated interest names (where the latter interests 31 are generated in accordance with, for example, collaborative filtering rules). Each interest name 32 in the profile has keywords associated therewith.

As stated above, interests are also assigned attributes such as privacy, expertise, importance, duration, and preferences. For example, in terms of privacy an interest can be classified as being public (information freely available to others), restricted (information only available to authorised persons) or private (information not available to any other users). In terms of expertise, a user can be described as being expert, advanced, intermediate, curious or beginner in respect of an interest (other categories are possible, and would be envisaged by the skilled person). In terms of importance to a user, an interest can be classified as having low, medium or high importance (that is to say that a user would prioritise an interest according to the importance of the interest to the user). In terms of duration of relevance to a user, an interest can be classified as having short, medium, or long term relevance and can be accompanied by an associated expiration date. Preferences include who, what, where, and how aspects of the interest. For example, someone interested in “golf” could also specify “who=Tom, Nancy”, “when=Saturday AM”, “where=Royal Country Club” to indicate favourite partners and preferred time and place of play. Empty or blank preference attributes are allowed.

Default classifications, such as expertise=“curious”, privacy=“public”, and importance=“low”, preference_who=“none” can be assigned to an interest.

Referring to FIG. 8, the interest information described with reference to FIG. 7 can be stored as a plurality of text files, each relating to an interest. In one arrangement there are three text files corresponding to each interest:

access/category name 71—“access” includes attribute information given by expertise, importance, duration, preferences and privacy etc.

interest/category name 72—this contains the positive keywords for the interest.

Nointerest/category name 73—this contains the negative keywords for the interest

In an alternative arrangement there is one file per interest, and the information relating to access, interest and nointerest is partitioned within the file.

Referring back to FIG. 6, the same interest name can appear against more than one role, and thus can have different keywords and classification information associated therewith (i.e. the same word can have a different meaning or different classification information associated therewith). For example, for a particular interest, access information that is stored in the access/category name 71 is likely to depend on role since privacy restrictions will almost certainly vary as a function of level in the organisation chart 317. An interest name can thus have several versions, each being a function of role in an organisation. When information relating to an interest name is stored in three text files 71, 72, 73 as described above, there may be several corresponding versions of each text file, and these can be mixed and matched as a function of role.

An interest/category name file 72 can be populated by identifying keywords or phrases from documents that are known to be of interest to a role, and saving them to the file 72.

For instance, a keyword extractor tool may be applied to documents accessed by a technical group so as to extract keywords from the documents. For example, the summarising tool described international patent application GB98/01119 (publication number WO98/47083) and the tool described in European patent application EP953920A2, which generates technical information relevant to user groups, could be applied to selected documents. Additionally, or alternatively, the interest/category file 72 could be populated using business cards, descriptions of special interest groups, Web pages belonging to a particular group, or job descriptions and the like.

Clearly the nointerest/category file 73 could be populated by applying an extractor tool to documents that are acknowledged as being irrelevant to a role, and/or a prebuilt list of “bad phrases” associated with known interest topics (e.g. for an interest named “agents” under the “artificial intelligence” category, bad phrases could be “real estate agent”, “travel agent”, “secret agent”), and saving the keywords extracted therefrom in the file 73.

In use, once the selecting program 315 has filtered the user template (for a user) in accordance with interests, the defining program 323 is arranged to select a version of an interest that corresponds to the user's role, and populate the user profile 17 therewith. As shown in FIG. 9, an individual user profile 17 thus comprises a plurality of interests (those filtered from the user profile template, annotated “1” to “n” in FIG. 9) represented by positive, negative and attribute information retrieved from the text files 71, 72, 73.

Thus far it has been assumed that all keywords/phrases associated with an interest (in files 72 and 73) are “treated equally”—i.e. conceptually they have the same “weight” with regards to their importance or relevance (or irrelevance, in the case of the negative keywords) to an interest. However, some keywords may be expected to be more relevant to an interest than others—e.g. keyword X may be very relevant to interest 1, and keyword Y may be only slightly relevant to 1. If a “neutral weight W” has value of 1, the relevance of these keywords can be represented as Wx=2 and Wy=0.5, which signifies that keyword X is about 4 times as important as keyword Y (Alternatively, the weight ranges can range from 0 to 1, 1 to 10, or employ fuzzy sets or some other scale). The interest attributes (importance rating, duration factor, keyword weights, and parts of the preferences) could similarly be weighted.

In addition to specifying and modifying weights in the interest files 71, 72 and 73, once a user profile 17 has been created, the weights therein can be modified to suit the individual user. Weighting keywords in this manner is a particularly useful refinement of individual user profiles 17, as the “meaning” and importance of a meaning is likely to vary from individual to individual. In use, the addition of weight parameters results in a more refined representation of the user's interests. When other applications (e.g. advanced search engines) have access to a profile, they can make use of the weights to fine-tune their services, thereby refining the quality of search and retrieval of information.

The defining program 323 could modify the files 71, 72, 73 using information available from one or some of the applications 18, 19, 20, 21 that access the profile store PS. As described above, the profile generator 16 may conveniently communicate with one or more of the applications 18, 19, 20 and 21 via the API. The “over-the-shoulder” information retrieval agent 20 monitors the behaviour patterns of users, and sends the information identified thereby to the defining program 323 for processing. The “matchmaking” agent 19 identifies groups of users having similar interests, and sends these interests, together with details of the users relating thereto, to the defining program 323. The defining program 323 then identifies the role of the user in respect of whom information has been received from an application, using, for example, the organisation chart 317, and updates the mapping 319 corresponding to that role.

In addition, the defining program 323 is arranged to modify individual user profiles 17, based on information indicative of the relevance, or otherwise, of certain keywords and attributes to an interest, received from the applications 18, 19, 20, 21. For example, for each keyword, the over-the-shoulder agent 20 could monitor the frequency and number of documents accessed by the user that contain the keyword. It could pass this data to the defining program 323, which is arranged to perform some relative statistical processing and rule-based reasoning of the data to identify relative weights to assign to the keywords and attributes. In particular, the defining program 323 can be arranged to use the data from multiple agents 18, 19, 20, 21 and process fuzzy logic based rules such as:

“IF doc_access_about_interest IS high THEN importance IS moderately_increased”

“IF activity_on_interest IS recently_absent THEN duration_factor IS slightly_decreased”

“IF keyword_in_docs IS very_low THEN kw_weight IS decreased”

The terms in italics are variables whose values are computed based on frequency of usage/appearance within certain time intervals, and the terms in bold are representative of fuzzy sets. (When information is received relating to a group of users, say a group within a particular role, these rules, or variants thereon, could also be used to modify files 71, 72, 73 relating to that role).

Alternatively and/or additionally the weights can be accessed (viewed/modified) manually by the user.

In some instances the applications 18, 19, 20, 21 may be authenticated to directly make changes to the interests—either to the keywords and classification information in files 71, 72, 73 or to the mapping 319—in which case the applications do not need to involve the defining program 323.

The following describes two uses of the defining program 323.

User adding an interest to a profile template:

Defining program 323 displays form for user to fill in

User enters information

interest name (any name the user wishes)

positive keywords (any keywords that describe this interest for them—what it is they want to find information about)

negative keywords (any keywords to exclude regarding this interest category)

select values for attributes (privacy, expertise, priority/importance, duration, preferences)

User selects folder to store interest under in profile (creates a flat 2-level hierarchy, e.g. adding the category “software” under a “Computing” profile).

Defining program 323 adds new interest to profile template and writes updated profile template information to store 313 (immediately available to all agents using profile so they get the latest information).

(in this example the interest is not classified as a function of role 90)

Updating an existing interest in a user's profile 17:

Defining program 323 displays view of profile 17 for the user, showing all current interests

User selects which interest to update

Defining program 323 retrieves all interest information from the profile & displays on screen for user to amend

User makes changes to expertise, importance, privacy, duration, preferences, keywords

Defining program 323 checks authentication level and updates interest information in profile & writes updated profile information to user's profile 17 (i.e. to files 71, 72, 73).

Additional Details

The profile (in particular the structure and hierarchical relationships between interests) can alternatively and/or additionally be defined by the user. When the user profile is viewed by a user, the interest classifications (e.g. levels of importance, privacy etc.) can be indicated using a different colour for each level. Insofar as the personal profile generator 16 is a Web server, the profile generator 16 is arranged to dynamically generate HTML so that a user can view his profile 17 and directly modify it using his Web browser.

The personal profile generator 16 may use additional user information to that described above, for example e-mails, local documents, personal schedule and contacts information that are accessible from the user terminals 1, 2, 3.

Implementation Details

The user computers 1, 2, 3 are personal computers running an operating system such as Windows, Windows NT, MacOS, Linux, or Unix, and browsers such as Internet Explorer or Netscape that support the HTTP protocol. The servers 4, 5, 6, 7 are computers running Unix or a similar operating system. The API 50 is in the form of a Common Gateway Interface (CGI) script or a Java class.

In the description above, it is assumed that the profile management system only resides on the personal profile server 4. However, other applications (e.g. one or more of applications 18, 19, 20, 21) could reside on the server 4.

The personal profile generator 16 can also operate in the context of the arrangement shown in FIG. 10. In this arrangement a first user's personal computer 40 is connected to the Internet 41 via a first dial-up connection 42 to a first gateway 43, and a second user's personal computer 44 is connected to the Internet 41 via a second dial-up connection 45 and a second gateway 46. A server 47, on which the profile management system MS resides, and various data sources 48 are also connected to the Internet 41.

The personal profile generator 16 maintains personal profiles 17 for both of the first and second users. In this arrangement the components of the personal profile generator 16 operate and interact substantially as described above in connection with the first embodiment with such modifications to their behaviours as are necessary to take account of the dial-up connections.

In a further arrangement, the organisation structure 317 of the first embodiment is modified so that each element in the structure 317 refers to a team. Thus all users, who are members of a team, will be assigned an identical profile by the selecting program 315. This arrangement is useful where a team of people is working on the same project.

1. Apparatus for generating a user profile for use in an information management system, the user profile comprising interests deemed to be relevant to a user, the apparatus comprising:
classification means for classifying a user as a type of entity;
a mapping store comprising data indicative of mappings between entity type and interests;
a template store comprising one or more templates each comprising a plurality of interests;
identifying means in operative association with the mapping store and the classification means and arranged, in use, to identify data indicative of interests relevant to a user in accordance with classification of the user;
to retrieve a template from the template store; and
to generate a user profile from the retrieved template in accordance with the identified interests.

2. Apparatus according to claim 1, wherein the identifying means is arranged to filter the retrieved template in accordance with the identified interests, thereby generating the said user profile.

3. Apparatus according to claim 1 or claim 2, wherein the template store has access to a plurality of versions of each interest, each version corresponding to an entity type, and the identifying means is further arranged to filter interests within the retrieved template in dependence on the entity type.

4. Apparatus according to claim 1, wherein the identifying means is arranged to request a template corresponding to the identified interests, so that the template retrieved in response to the request is the generated user profile.

5. Apparatus according to any one of the preceding claims, wherein an interest is characterised by a plurality of sets of subject-related data and/or attributes classifying the interest.

6. Apparatus according to any one of the preceding claims, further comprising means for characterising an interest for loading onto a template, said characterising means comprising means for retrieving subject-related data from information accessed by one or more users.

7. Apparatus according to any one of the preceding claims, including means arranged to receive data indicative of relationships between entity types, and to modify interests in the mapping store in dependence on the received data.

8. Apparatus according to any one of the preceding claims, wherein the classification means is in operative association with a data structure, elements of which are representative of entity type.

9. Apparatus according to claim 8, wherein the data structure is representative of an organisation, and entity type is representative of role within the organisation.

10. A method of generating a user profile for use in an information management system, the user profile comprising interests deemed to be relevant to a user, the method comprising the steps of:
classifying a user as a type of entity;
accessing mappings between entity type and interests in order to identify interests corresponding to the classified user;
retrieving a template from a template store, the template store comprising one or more templates each comprising a plurality of interests;
generating a user profile from the retrieved template in accordance with the identified interests.

11. A user profile for use by one or more information management means in retrieval of information, the profile comprising
first data identifying a plurality of interests, and comprising, for each interest, subject-related terms related to the said interest and subject-related terms un-related to the said interest,
second data identifying attributes characterising an interest, the second data being used by the information management means to filter information identified as being relevant to the first data.

12. A user profile according to claim 11, wherein an item of the subject-related data is weighted to indicate a level of relevance of the subject-related data to a respective interest.

13. A user profile according to claim 11 or claim 12, wherein the second data includes data describing the priority of the first data to the user.

14. A user profile according to any one of claims 11 to 13, wherein the second data includes data describing duration of relevance of the first data to the user

15. A user profile according to any one of claims 11 to 14, wherein the second data includes data indicative of an expertise level of the user in respect of the first data

16. A user profile according to any one of claims 11 to 15, wherein the second data includes preference data describing preferences of the user in respect of the first data

17. A user profile according to claim 16, wherein the preference data identifies at least one of: to whom the first data is relevant; to a place at which the first data is relevant and/or a time at which the first data is relevant.

18. A user profile according to any one of claims 11 to 17, wherein the second data includes data indicative of the extent to which the first data should be made available to other users.
